(19) United States
(12) Patent Application Publication
(10) Pub. No.: US 2004/0207636 A1
(43) Pub. Date: Oct. 21, 2004

(54) Partitioning graph structures using external constraints

(76) Inventors: Alan Messer, Los Gatos, CA (US); Ira Greenberg, Mountain View, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/418,484

(22) Filed: Apr. 18, 2003

(51) Int. Cl. G09G 5/00

(52) U.S. Cl. 345/619

(57) ABSTRACT

A method for partitioning a graph structure takes into account external information that influence the desirability of partitionings. A method according to the present techniques includes determining a set of intermediate partitionings of the graph structure and determining a set of partitioning metrics for each intermediate partitioning in response to a set of external information pertaining to the graph structure. A partitioning is selected from among the intermediate partitionings using a partitioning policy that combines the partitioning metrics.

### BACKGROUND OF THE INVENTION

1. Field of Invention

The present invention pertains to the field of graph structures. More particularly, this invention relates to partitioning graph structures.

2. Art Background

A wide variety of problems in computers, science, and engineering may be represented using graph structures. For example, graph structures may be used to represent computer programs, control systems, environmental systems, etc.

A typical graph structure includes a set of nodes that represent elements of a corresponding problem and a set of possibly weighted edges that represent relationships among the nodes. For example, a graph structure of a computer program typically includes a set of nodes that represent the software components of the computer program and a set of weighted edges that represent interactions among the software components.

It is often desirable in a variety of circumstances to partition a graph structure. For example, a computer program may be partitioned for execution on separate computer systems by partitioning a graph structure that represents the computer program.

Prior methods for partitioning a graph structure usually base partitioning decisions only on information provided by the nodes and the weighted edges of the graph structure. Unfortunately, such methods usually do not take into account factors that are external to the graph structure but which may have impact on the desirability of a partitioning.

### SUMMARY OF THE INVENTION

A method for partitioning a graph structure is disclosed that takes into account external information that influences the desirability of partitionings. A method according to the present techniques includes determining a set of intermediate partitionings of the graph structure and determining a set of partitioning metrics for each intermediate partitioning in response to a set of external information pertaining to the graph structure. A partitioning is selected from among the intermediate partitionings using a partitioning policy that combines the partitioning metrics.

Other features and advantages of the present invention will be apparent from the detailed description that follows.

### BRIEF DESCRIPTION OF THE DRAWINGS

The present invention is described with respect to particular exemplary embodiments thereof and reference is accordingly made to the drawings in which:

FIG. 1 shows one embodiment of a partitioning system according to the present teachings;

FIG. 2 illustrates an example of a graph structure including a set of nodes interconnected by a corresponding set of edges each of which has a corresponding weight;

FIG. 3 shows one embodiment of a method for partitioning a graph structure according to the present techniques;

FIG. 4 illustrates an example set of results of a partitioning policy applied to a set of intermediate partitionings.

### DETAILED DESCRIPTION

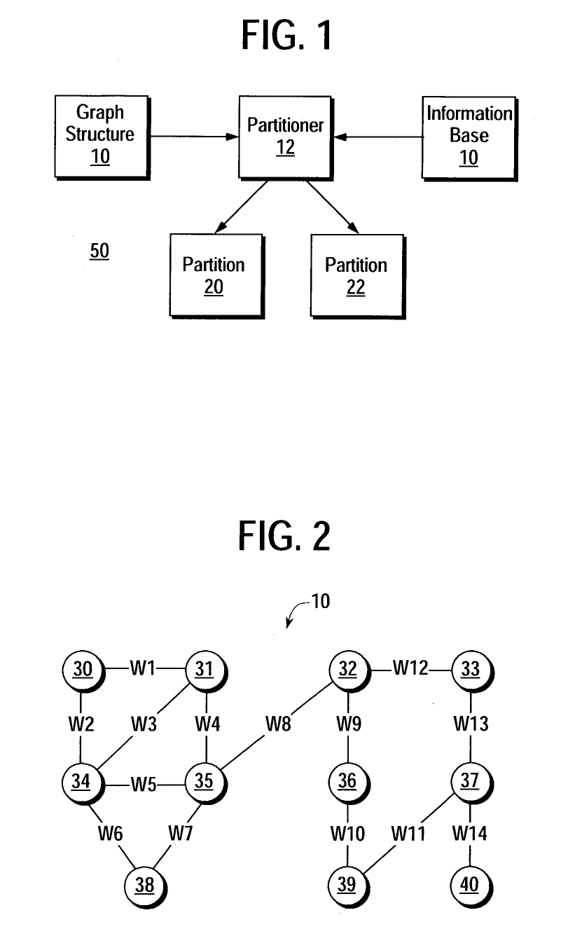

FIG. 1 shows a partitioning system 50 according to the present teachings. The partitioning system 50 includes a partitioner 12 that partitions a graph structure 10 into a set of partitions 20-22 in response to information contained in the graph structure 10 and in response to a set of information contained in an information base 14.

The graph structure 10 represent elements of a corresponding system or problem under consideration. For example, the graph structure 10 may represent a computer program to be executed on one or more computer systems or a control system which is to be deployed in a distributed environment to name a couple of possibilities.

The graph structure 10 may be generated in any number of ways. For example, a graph structure that represents a computer program may be generated by a program simulator or by monitoring the execution of the computer program. Similarly, a graph structure of a control system may be generated by a simulator or by monitoring the control system when in use.

The information in the information base 14 is information that is external to the graph structure 10 that may influence the desirability of partitionings to be performed on the graph structure 10. The information in the information base 14 may include data and/or constraints that are external to the graph structure 10 but that pertains to the system or problem represented by the graph structure 10.

For example, if the graph structure 10 represents a computer program to be executed on a computer system then the information base 14 may include information pertaining to the computer system that may be useful in partitioning the graph structure 10. Information pertaining to a computer system that may be useful in partitioning a computer program may include information pertaining to resource consumption including constraints on resource consumption, information pertaining to program execution performance including constraints on response time, information pertaining to power consumption including constraints on power consumption, information pertaining to communication network load including constraints on communication, etc. Other constraints that may be included in the information base 14 include a list of software components that my not be partitioned or relocated as well as other static constraints.

The elements of the partitioning system 50 may be implemented on a computer system including a combination of hardware and software elements for performing the techniques disclosed herein.

FIG. 2 illustrates an example of the graph structure 10 that includes a set of nodes 30-40 which are interconnected by a corresponding set of edges each of which has a corresponding weight w1-w14. The edges may be directed or undirected. The representations provided by the nodes 30-40 and the weighted edges w1-w14 depend on the nature of the corresponding problem or system being represented.

For example, if the graph structure 10 represents a computer program then each of the nodes 30-40 represents a software component of the computer program and the weights w1-w14 represent the magnitude of some interaction between the corresponding software components. The weights w1-w14 may represent the amount of data passed between the corresponding software components or may represent the frequency of interaction between the corresponding software components or a combination of these factors. For example, the weight w1 may be a combined factor that represents the amount of data passed between the software components associated with the nodes 30 and 31 and the frequency of interaction between the software components associated with the nodes 30 and 31. Such a combined factor is related to the communication bandwidth needed between the software components associated with the nodes 30 and 31.

A particular division of the nodes 30-40 among the partitions 20-22 may be referred to as a partitioning of the graph structure 10.

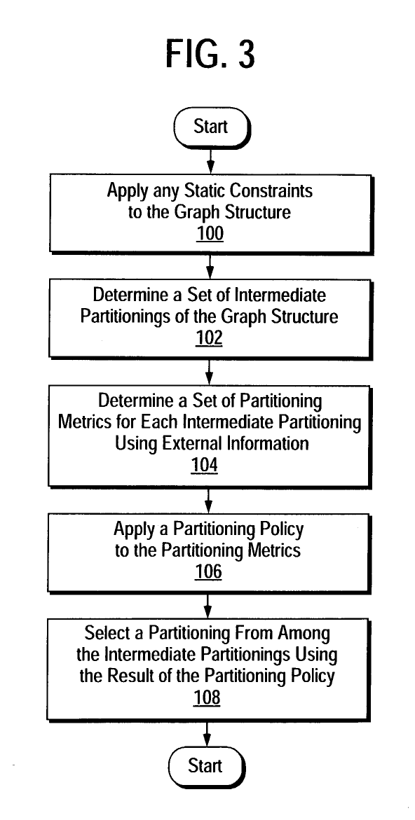

FIG. 3 shows a method for partitioning the graph structure 10 according to the present techniques. At step 100, the partitioner 12 applies any static constraints to the graph structure 10. A static constraint may hinder the partitioning of one or more of the nodes 30-40. For example, the elements associated with the nodes 30 and 31 may not be amenable to partitioning. The graph structure 10 may for example be a computer program that executes in a virtual machine environment and the nodes 30 and 31 may represent native routines that cannot be readily relocated to other computer systems.

At step 102, the partitioner 12 determines a set of N intermediate partitionings of the nodes in the graph structure 10 that did not meet the static constraints applied at step 100. In this example, N equals 9, which is the number of nodes 30-40 minus the two nodes 30 and 31 that did not meet the static constraints. As a consequence, the partitioner 12 determines N=9 intermediate partitionings of the graph structure 10 at step 102.

In one embodiment, the partitioner 12 determines a first intermediate partitioning by initially selecting one of the nodes 32-40 at random—for example the node 33. The partitioner 12 then selects the neighbor of the node 33 having the highest level of mutual interactions as indicated by the corresponding weighted edge and groups them together. For example, if w12 is greater than w13 then the partitioner 12 chooses the neighbor node 32. This results in a first intermediate partitioning with the nodes 32 and 33 grouped together in the partition 20 and the nodes 34-40 grouped together in partition 22. The partitioner 12 then chooses the neighbor of the node 32-33 partitioning having the highest level of mutual interactions. For example, the partitioner 12 chooses the node 35 if w8 is greater than w9 or w13. This results in a second intermediate partitioning with the nodes 32 and 33 and 35 together in the partition 20 and the nodes 34 and 36-40 together in the partition 22. The partitioner 12 repeats this process N times to derive N intermediate partitionings.

At step 104, the partitioner 12 determines a set of S partitioning metrics (M[1]-M[S]) for each of the N intermediate partitionings from step 102 using information external to the graph structure 10 possibly combined with information in the graph structure 10. The partitioning metrics for the first intermediate partitioning are M[1,1]-M[1,S] and the partitioning metrics for the second intermediate partitioning are M[2,1]-M[2,S], etc., which yields the partitioning metrics M[1,1]-M[N,S] at step 104.

The partitioner 12 determines the partitioning metrics M[1,1]-M[N,S] using information from the information base 14. The following focuses on an example in which the graph structure 10 represents a computer program. These techniques may nevertheless be readily adapted to graph structures that represent other problems or systems.

One example of a partitioning metric is a memory consumption metric. A memory consumption metric may be determined in a variety of ways. For example, a memory consumption metric for an intermediate partitioning may take into account the size of the software components in the partitions in the intermediate partitioning and a constraint on an available amount of free memory in the computer systems onto which the partitions of the intermediate partitioning are to be deployed. The amount of free memory space in a computer system and the size of the software components in terms of memory space may be recorded in the information base 14. A memory consumption metric for an intermediate partitioning may take into account whether the software components in the partitions of the intermediate partitioning are likely to become components that need to be cleaned up by a “garbage collection” routine of a virtual machine under which the partitions execute. A list of software components that are likely to become garbage may be contained in the information base 14. These factors and many others may be combined together into a memory consumption metric in any conceivable way and the factors may have associated weights as appropriate. For example, the likelihood that software components will become garbage may be given greater weight than the size of the software components. A memory consumption metric may be a number between 0 and 1 with, for example, a 1 indicating a highest score with respect to desirable memory consumption characteristics and a 0 indicating a lowest desirability score.

Another example of a partitioning metric is a performance metric. A performance metric for an intermediate partitioning may be a prediction of response time of the computer systems that are to execute the partitions of the intermediate partitioning. A predicted response time may be application-specific. A predicted response time may be determined using information in the information base 14 which may include, for example, information on the hardware capabilities of the computer systems that are to execute the partitions of an intermediate partitioning and other information pertaining to performance such as other software components being executed on the computer systems or other constraints. The performance metric may be a number between 0 and 1 with, for example, a 1 indicating a highest predicted performance and a 0 indicating a lowest predicted performance.

Yet another example of a partitioning metric is a power consumption metric. A power consumption metric for an intermediate partitioning may be a prediction of the power consumption of computer systems when executing the partitions of the intermediate partitioning. The information base 14 may include the power consumption characteristics of the software components when executed on target computer systems and this information may be used to determine a power consumption metric for the partitions of an intermediate partitioning. The power consumption metric may be a number between 0 and 1 with, for example, a 1 indicating a highest predicted power consumption and a 0 indicating a lowest predicted power consumption.

Another example of a partitioning metric is a network load metric. A network load metric may be a prediction of a load on a network that connects the computer systems that are to execute the partitions of an intermediate partitioning. The network load may be predicted using the weighted edges between the nodes that connect the partitions of an intermediate partitioning along with information in the information base 14 that pertains to network traffic. Such information may include, for example, the bandwidth capacity of a network and other loads or constraints imposed by other activity on the network. The network load metric may be a number between 0 and 1 with, for example, a 1 indicating a highest predicted network load and a 0 indicating a lowest predicted network load.

The above are only a few examples of partitioning metrics. Numerous others are possible in accordance with the present techniques.

Table 1 shows the results of step 104 for the example graph structure 10 given N=9 intermediate partitionings and S=3 partitioning metrics.

TABLE 1

| | Partitioning | Partitioning | Partitioning |
|---|---|---|---|
| | Metric 1 | Metric 2 | Metric 3 |
| Intermediate | M[1, 1] | M[1, 2] | M[1, 3] |
| Partitioning 1 | | | |
| Intermediate | M[2, 1] | M[2, 2] | M[2, 3] |
| Partitioning 2 | | | |
| Intermediate | M[3, 1] | M[3, 2] | M[3, 3] |
| Partitioning 3 | | | |
| Intermediate | M[4, 1] | M[4, 2] | M[4, 3] |
| Partitioning 4 | | | |
| Intermediate | M[5, 1] | M[5, 2] | M[5, 3] |
| Partitioning 5 | | | |
| Intermediate | M[6, 1] | M[6, 2] | M[6, 3] |
| Partitioning 6 | | | |
| Intermediate | M[7, 1] | M[7, 2] | M[7, 3] |
| Partitioning 7 | | | |
| Intermediate | M[8, 1] | M[8, 2] | M[8, 3] |
| Partitioning 8 | | | |
| Intermediate | M[9, 1] | M[9, 2] | M[9, 3] |
| Partitioning 9 | | | |

At step 106, the partitioner 12 applies a partitioning policy to each of the N intermediate partitionings from step 102 by combining the corresponding S partitioning metrics M[1]-M[S]. For example, the partitioner 12 applies a partitioning policy to the first intermediate partitioning by combining the partitioning metrics M[1,1]-M[1,S] into an overall partitioning score (P1) and applies a partitioning policy to the second intermediate partitioning by combining the partitioning metrics M[2,1]-M[2,S] into an overall partitioning score (P2), etc.

The partitioning metrics may be combined using a polynomial expression. One example of a polynomial expression for combining the partitioning metrics of the intermediate partitioning 1 is as follows:

P1=x1*M[1,1]+x2*M[1,2]+ . . . Xs*M[1,S]

where x1-xs are selected to provide appropriate weight to the S partitioning metrics in the overall partitioning score. Alternatively, numerous other techniques for combining the partitioning metrics may be employed.

At step 108, a partitioning is selected from among the intermediate partitionings of step 102 based on results of the partitioning policy applied at step 106. The intermediate partitioning with the best, for example highest, overall partitioning score P is used to provide the partitions 20-22. The steps of generating partitioning metrics using information external to the graph structure 10 and combining the metrics using the weights x1-xs enables a partitioning policy in which information external to the graph structure 10 may take precedence over or be appropriately balance with the information in the graph structure 10 including its weighted edges w1-w14.

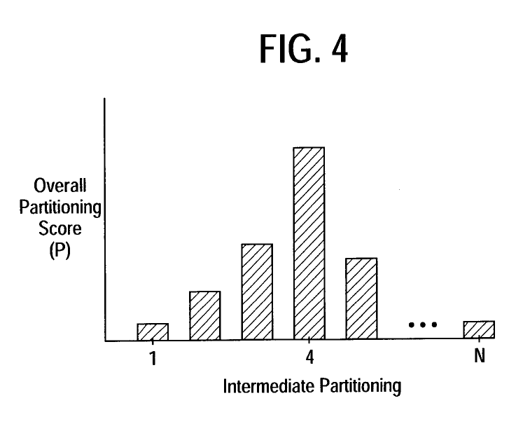

FIG. 4 illustrates the results of the partitioning policy applied at step 106. A graph is shown of the overall partitioning score P verses the intermediate partitionings 1-N. In this example, a highest overall partitioning score corresponds to an intermediate partitioning 5 and the intermediate partitioning 5 is selected at step 108 to provide the partitions 20-22.

The foregoing detailed description of the present invention is provided for the purposes of illustration and is not intended to be exhaustive or to limit the invention to the precise embodiment disclosed. Accordingly, the scope of the present invention is defined by the appended claims.

What is claimed is:

1. A method for partitioning a graph structure, comprising the steps of:
determining a set of intermediate partitionings of the graph structure;
determining a set of partitioning metrics for each intermediate partitioning in response to a set of external information pertaining to the graph structure;
selecting a partitioning of the graph structure from among the intermediate partitionings using a partitioning policy that combines the partitioning metrics.

2. The method of claim 1, wherein the step of selecting comprises the steps of:
determining an overall score for each intermediate partitioning using the partitioning policy;
selecting the intermediate partitioning having a best overall score.

3. The method of claim 1, wherein the step of selecting includes the step of combining the partitioning metrics for each intermediate partitioning using a polynomial expression.

4. The method of claim 1, wherein the step of determining a set of partitioning metrics comprises the step of determining a memory consumption metric for each intermediate partitioning.

5. The method of claim 1, wherein the step of determining a set of partitioning metrics comprises the step of determining a performance metric for each intermediate partitioning.

6. The method of claim 1, wherein the step of determining a set of partitioning metrics comprises the step of determining a power consumption metric for each intermediate partitioning.

7. The method of claim 1, wherein the step of determining a set of partitioning metrics comprises the step of determining a network load metric for each intermediate partitioning.

8. The method of claim 1, wherein the step of determining a set of intermediate partitionings of the graph structure comprises the step of determining a set of intermediate partitionings of the graph structure in response to a set of weighted edges that connect a set of nodes in the graph structure.

9. The method of claim 1, wherein the step of determining a set of partitioning metrics comprises the step of determining the partitioning metrics in response to the external information that specifies resource consumption of a computer program represented by the graph structure.

10. The method of claim 1, wherein the step of determining a set of partitioning metrics comprises the step of determining the partitioning metrics in response to the external information that specifies program execution performance of a computer program represented by the graph structure.

11. The method of claim 1, wherein the step of determining a set of partitioning metrics comprises the step of determining the partitioning metrics in response to the external information that specifies power consumption of a computer program represented by the graph structure.

12. The method of claim 1, wherein the step of determining a set of partitioning metrics comprises the step of determining the partitioning metrics in response to the external information that specifies communication network load of a computer program represented by the graph structure.

13. The method of claim 1, wherein the graph structure represents a computer program having a set of software components and the partitioning specifies a set of partitions each comprising a subset of the software components.

14. The method of claim 13, wherein the step of determining a set of partitioning metrics comprises the step of determining a memory consumption metric in response to the external information that specifies a size of each software component.

15. The method of claim 13, wherein the step of determining a set of partitioning metrics comprises the step of determining a memory consumption metric in response to the external information that specifies an available amount of free memory in a set of computer systems onto which the partitions are to be deployed.

16. The method of claim 13, wherein the step of determining a set of partitioning metrics comprises the step of determining a memory consumption metric in response to the external information that specifies the software components that are likely to become components cleaned up by a garbage collection routine of a virtual machine.

17. The method of claim 13, wherein the step of determining a set of partitioning metrics comprises the step of determining a performance metric in response to the external information that specifies the hardware capabilities of a set computer systems that are to execute the partitions.

18. The method of claim 13, wherein the step of determining a set of partitioning metrics comprises the step of determining a power consumption metric in response to the external information that specifies power consumption characteristics of the software components when executed on a set of computer systems onto which the partitions are to be deployed.

19. The method of claim 13, wherein the step of determining a set of partitioning metrics comprises the step of determining a network load metric in response to the external information that specifies bandwidth capacity of a network for communication among a set of computer systems onto which the partitions are to be deployed.

20. A partitioning system, comprising:
information base that provides a set of external information pertaining to a graph structure;
partitioner that determines a set of intermediate partitionings of the graph structure and a set of partitioning metrics for each intermediate partitioning in response to the external information and then selects a partitioning of the graph structure from among the intermediate partitionings using a partitioning policy that combines the partitioning metrics.

21. The partitioning system of claim 20, wherein the partitioner selects the partitioning by determining an overall score for each intermediate partitioning using the partitioning policy and selecting the intermediate partitioning having a best overall score.

22. The partitioning system of claim 20, wherein the partitioner selects the partitioning by combining the partitioning metrics for each intermediate partitioning using a polynomial expression.

23. The partitioning system of claim 20, wherein the partitioner determines the partitioning metrics by determining a memory consumption metric for each intermediate partitioning using the external information.

24. The partitioning system of claim 20, wherein the partitioner determines the partitioning metrics by determining a performance metric for each intermediate partitioning using the external information.

25. The partitioning system of claim 20, wherein the partitioner determines the partitioning metrics by determining a power consumption metric for each intermediate partitioning using the external information.

26. The partitioning system of claim 20, wherein the partitioner determines the partitioning metrics by determining a network load metric for each intermediate partitioning using the external information.

27. The partitioning system of claim 20, wherein the partitioner determines a set of intermediate partitionings of the graph structure by determining a set of intermediate partitionings of the graph structure in response to a set of weighted edges that connect a set of nodes in the graph structure.

28. A computer-readable storage media that contains a program that when executed by a computer partitions a graph structure by performing the steps of:
determining a set of intermediate partitionings of the graph structure;
determining a set of partitioning metrics for each intermediate partitioning in response to a set of external information pertaining to the graph structure;
selecting a partitioning of the graph structure from among the intermediate partitionings using a partitioning policy that combines the partitioning metrics.

29. The computer-readable storage media of claim 28, wherein the step of selecting comprises the steps of:
determining an overall score for each intermediate partitioning using the partitioning policy;
selecting the intermediate partitioning having a best overall score.

30. The computer-readable storage media of claim 28, wherein the step of selecting includes the step of combining the partitioning metrics for each intermediate partitioning using a polynomial expression.

31. The computer-readable storage media of claim 28, wherein the step of determining a set of partitioning metrics comprises the step of determining a memory consumption metric for each intermediate partitioning.

32. The computer-readable storage media of claim 28, wherein the step of determining a set of partitioning metrics comprises the step of determining a performance metric for each intermediate partitioning.

33. The computer-readable storage media of claim 28, wherein the step of determining a set of partitioning metrics comprises the step of determining a power consumption metric for each intermediate partitioning.

34. The computer-readable storage media of claim 28, wherein the step of determining a set of partitioning metrics comprises the step of determining a network load metric for each intermediate partitioning.

35. The computer-readable storage media of claim 28, wherein the step of determining a set of intermediate partitionings of the graph structure comprises the step of determining a set of intermediate partitionings of the graph structure in response to a set of weighted edges that connect a set of nodes in the graph structure.

36. The computer-readable storage media of claim 28, wherein the step of determining a set of partitioning metrics comprises the step of determining the partitioning metrics in response to the external information that specifies resource consumption of a computer program represented by the graph structure.

37. The computer-readable storage media of claim 28, wherein the step of determining a set of partitioning metrics comprises the step of determining the partitioning metrics in response to the external information that specifies program execution performance of a computer program represented by the graph structure.

38. The computer-readable storage media of claim 28, wherein the step of determining a set of partitioning metrics comprises the step of determining the partitioning metrics in response to the external information that specifies power consumption of a computer program represented by the graph structure.

39. The computer-readable storage media of claim 28, wherein the step of determining a set of partitioning metrics comprises the step of determining the partitioning metrics in response to the external information that specifies communication network load of a computer program represented by the graph structure.

40. The computer-readable storage media of claim 28, wherein the graph structure represents a computer program having a set of software components and the partitioning specifies a set of partitions each comprising a subset of the software components.

41. The computer-readable storage media of claim 40, wherein the step of determining a set of partitioning metrics comprises the step of determining a memory consumption metric in response to the external information that specifies a size of each software component.

42. The computer-readable storage media of claim 40, wherein the step of determining a set of partitioning metrics comprises the step of determining a memory consumption metric in response to the external information that specifies an available amount of free memory in a set of computer systems onto which the partitions are to be deployed.

43. The computer-readable storage media of claim 40, wherein the step of determining a set of partitioning metrics comprises the step of determining a memory consumption metric in response to the external information that specifies the software components that are likely to become components cleaned up by a garbage collection routine of a virtual machine.

44. The computer-readable storage media of claim 40, wherein the step of determining a set of partitioning metrics comprises the step of determining a performance metric in response to the external information that specifies the hardware capabilities of a set computer systems that are to execute the partitions.

45. The computer-readable storage media of claim 40, wherein the step of determining a set of partitioning metrics comprises the step of determining a power consumption metric in response to the external information that specifies power consumption characteristics of the software components when executed on a set of computer systems onto which the partitions are to be deployed.

46. The computer-readable storage media of claim 40, wherein the step of determining a set of partitioning metrics comprises the step of determining a network load metric in response to the external information that specifies bandwidth capacity of a network for communication among a set of computer systems onto which the partitions are to be deployed.
